(19) United States
(12) Patent Application Publication
(10) Pub. No.: US 2024/0181345 A1
(43) Pub. Date: Jun. 6, 2024

(54) COMPUTER-READABLE NON-TRANSITORY STORAGE MEDIUM, GAME SYSTEM, GAME APPARATUS, AND GAME PROCESSING METHOD

(71) Applicant: NINTENDO CO., LTD., Kyoto (JP)

(72) Inventor: Koichi SATO, Kyoto (JP)

(21) Appl. No.: 18/461,834

(22) Filed: Sep. 6, 2023

(30) Foreign Application Priority Data
Dec. 1, 2022 (JP) 2022-193114

(51) Int. Cl. A63F 13/54; A63F 13/525

(52) U.S. Cl. CPC A63F 13/54; A63F 13/525; A63F 2300/6081

(57) ABSTRACT

For a sound source in a virtual space, a volume related to the sound source is set so as to be attenuated in accordance with a distance between a first determination region having a predetermined shape and a virtual microphone. In addition, a hiding determination as to the sound source is performed on the basis of a positional relationship between the virtual microphone and a second determination region having a shape different from that of the first determination region, and the shape of the second determination region satisfies at least that a part thereof is outside the first determination region or that a width thereof is smaller than that of the first determination region. When the sound source is hidden, the volume is set so as to be further attenuated.

### CROSS REFERENCE TO RELATED APPLICATION

This application claims priority to Japanese Patent Application No. 2022-193114 filed on Dec. 1, 2022, the entire contents of which are incorporated herein by reference.

### FIELD

The present disclosure relates to sound control processing of outputting a sound to a speaker.

### BACKGROUND AND SUMMARY

Hitherto, a game in which a sound emitted from a large sound source, e.g., a river object, located in a virtual space is expressed has been known.

When a sound expression is performed for a sound source located in a virtual three-dimensional space, if the sound source has a relationship in which the sound source is hidden when viewed from a virtual microphone, it is conceivable to apply a volume or filter to the sound from the sound source such that the sound is heard as a muffled sound.

Here, when a hiding determination as to whether or not the above-described river object is hidden when viewed from the virtual microphone is performed, it is conceivable to perform the hiding determination on the basis of one point, closest to the virtual microphone, in the river. As a result, if the closest point is hidden when viewed from the virtual microphone, the sound of the river is determined to be blocked, and a muffled sound expression is performed. However, for example, even though most of the river is not hidden on a screen, if the point closest to the virtual microphone is hidden, a sound expression may be performed such that the entire sound of the river is muffled. In such a case, a player may be given an uncomfortable feeling or unnaturalness for the sound in relation to the appearance of the river on the screen.

Therefore, an object of the present disclosure is to provide a computer-readable non-transitory storage medium having a game program stored therein, a game system, a game apparatus, and a game processing method that can prevent an unnatural hiding determination from being performed when a hiding determination is performed for a sound source.

In order to attain the object described above, for example, the following configuration examples are exemplified.

### (Configuration 1)

Configuration 1 is directed to a computer-readable non-transitory storage medium having stored therein a game program causing a computer of an information processing apparatus to:
control a position of a virtual microphone in a virtual space;
for a virtual first sound source placed in the virtual space and associated with a first sound,
   set a volume of the first sound such that the volume of the first sound is attenuated in accordance with a distance between a first determination region having a predetermined shape and the virtual microphone,
   perform a hiding determination as to the first sound source on the basis of a positional relationship between the virtual microphone and a second determination region having a shape different from that of the first determination region, the shape of the second determination region satisfying at least that a part thereof is outside the first determination region or that a width thereof is smaller than that of the first determination region, and
   set the volume of the first sound such that the volume of the first sound is further attenuated when the first sound source is hidden, on the basis of a result of the hiding determination; and
output the first sound on the basis of the set volume.

According to the above configuration example, a hiding determination as to a certain sound source is performed using the second determination region having a smaller width than the first determination region. Therefore, an unnatural determination result that it is determined that the entire sound source is hidden, due to an end of the sound source being locally hidden, can be inhibited from being obtained. In addition, the above hiding determination is performed on the basis of the second determination region whose part is outside the first determination region. Therefore, due to the existence of such a region which is outside the first determination region, it is made difficult to determine that the sound source is hidden. Accordingly, it is made easier to obtain a determination result that the sound source is not hidden when the sound source is viewed from various directions.

### (Configuration 2)

According to Configuration 2, in Configuration 1 described above, the distance between the first determination region and the virtual microphone may be a distance between a point, closest to the virtual microphone, on the first determination region and the position of the virtual microphone.

According to the above configuration example, a more appropriate hiding determination can be performed than in the case where a hiding determination is performed using the first determination region. For example, if a hiding determination is performed on the basis of the closest point on the first determination region, it may be determined that the entire sound source is hidden even though there is a portion that is not hidden. However, according to this configuration example, it can be inhibited from being determined as above.

### (Configuration 3)

According to Configuration 3, in Configuration 2 described above, the game program may cause the computer to: determine whether or not an obstacle object exists between a reference point based on the position of the virtual microphone and a point, closest to the reference point, on the second determination region in the virtual space; and when it is determined that the obstacle object exists, determine that the first sound source is hidden.

According to the above configuration example, the reference point based on the position of the virtual microphone is used for the hiding determination. Accordingly, a more flexible and appropriate hiding determination corresponding to a situation can be performed.

### (Configuration 4)

According to Configuration 4, in Configuration 2 or 3 described above, the game program may cause the computer to: determine whether or not an obstacle object exists between a reference point based on the position of the virtual microphone and a point, closest to the reference point, on the second determination region in the virtual space; when it is determined that the obstacle object exists, further determine whether or not a path bypassing the obstacle object within a predetermined range exists between the virtual microphone and a point, closest to the virtual microphone, on the second determination region; when it is determined that the path exists, determine that the first sound source is hidden to a first degree; when it is determined that the path does not exist, determine that the first sound source is hidden to a second degree higher than the first degree; and set the volume such that the volume is attenuated on the basis of the determined hiding degree.

According to the above configuration example, a sound expression that takes sound diffraction into account can be performed, so that a sound expression that gives a less uncomfortable feeling can be performed.

### (Configuration 5)

According to Configuration 5, in Configuration 4 described above, the game program may cause the computer to: when it is determined that the bypassing path does not exist, further determine whether or not a position of the reference point and the point closest to the reference point are positions indicating indoor spaces preset in the virtual space; and when either one of the position of the reference point and the point closest to the reference point is the position indicating the indoor space, determine that the first sound source is hidden to a third degree higher than the second degree.

According to the above configuration example, a sound expression that takes into account the case where the virtual microphone and the sound source have a relationship in which one of the virtual microphone and the sound source is indoors and the other is outdoors, can be performed.

### (Configuration 6)

According to Configuration 6, in any one of Configurations 3 to 5 described above, the first determination region may have a three-dimensional shape having a plurality of surfaces, and the second determination region may have a planar shape along one of the surfaces of the first determination region.

According to the above configuration example, a surface, of a certain sound source, considered to emit a sound can be used for the hiding determination. Accordingly, a sound expression that gives a less uncomfortable feeling in relation to the appearance of an image displayed on a screen can be performed.

### (Configuration 7)

According to Configuration 7, in any one of Configurations 3 to 5 described above, an object corresponding to the first sound source may be placed in the virtual space, the first determination region may be placed along the object corresponding to the first sound source, and the second determination region may have a shape in which the second determination region has a smaller width than the first determination region and protrudes toward a position where the object is not placed in the virtual space.

According to the above configuration example, it can be inhibited from being determined that the entire sound source is hidden, due to an end of the sound source being locally hidden. In addition, by using the protruding shape portion, it is made easier to obtain a determination result that the sound source is not hidden when the sound source is viewed from various directions. Accordingly, a situation in which the sound is unnaturally heard so as to be muffled in relation to the appearance of an image displayed on the screen can be inhibited from occurring, so that a sound expression that gives a less uncomfortable feeling can be performed.

### (Configuration 8)

According to Configuration 8, in any one of Configurations 3 to 5 described above, a waterfall object corresponding to the first sound source may be placed in the virtual space, the first determination region may be placed along the waterfall object, and the second determination region may be placed along a surface, on a water surface side of the waterfall object, of the first determination region and may have a planar shape in which the second determination region has a smaller width in a width direction of the waterfall object than the first determination region and protrudes toward an upper side of the waterfall object.

According to the above configuration example, a more appropriate sound expression of the sound of the waterfall can be performed.

### (Configuration 9)

According to Configuration 9, in any one of Configurations 6 to 8 described above, the game program may further cause the computer to generate the second determination region on the basis of a shape of the first determination region.

According to the above configuration example, there is no need to store information about the second determination region in advance, for example, in a game cartridge or the like, and thus the storage capacity can be saved. In addition, the second determination region can be flexibly set according to first determination regions having various shapes.

### (Configuration 10)

According to Configuration 10, in Configuration 8 described above, the game program may further cause the computer to: generate the first determination region on the basis of a shape of the waterfall object; and generate the second determination region on the basis of a shape of the first determination region.

### (Configuration 11)

According to Configuration 11, in any one of Configurations 1 to 10 described above, the game program may further cause the computer to: control a position of the virtual camera in the virtual space; and set the position of the virtual microphone to the position of the virtual camera in the virtual space.

According to the above configuration example, the virtual camera and the virtual microphone are at the same position. Therefore, for example, in a first-person view screen, it is possible to perform processing that gives no uncomfortable feeling in terms of the way the sound is heard in relation to the appearance of the screen.

### (Configuration 12)

According to Configuration 12, in any one of Configurations 1 to 10 described above, the game program may further cause the computer to: set a strength at which a first filter is applied to the first sound, on the basis of the distance between the first determination region and the virtual microphone; when the first sound source is hidden on the basis of the result of the hiding determination as to the first sound source based on the positional relationship between the second determination region and the virtual microphone, further set the strength such that the first filter is applied more strongly, or set a strength at which a second filter is applied; and apply a filter to the first sound, and output the first sound on the basis of the volume.

According to the above configuration example, various filters that reflect the distance between the virtual microphone and the sound source and the hiding degree and give a predetermined sound effect can be applied. Accordingly, a sound expression that gives an even less uncomfortable feeling can be performed.

### (Configuration 13)

According to Configuration 13, in any one of Configurations 1 to 10 described above, the game program may further cause the computer to: calculate a localization of the first sound on the basis of a positional relationship between the first determination region and the virtual microphone; and output the first sound on the basis of the set localization.

According to the above configuration example, the position from which the sound is heard is set on the basis of the positional relationship between the first determination region and the virtual microphone. Therefore, a sound expression that gives no uncomfortable feeling regarding the relationship between the appearance of the display on the screen and the position from which the sound is heard, can be performed.

According to the exemplary embodiments, even when a part of a huge sound source is hidden when viewed from the virtual microphone, the entire sound source can be inhibited from being treated as being hidden, so that a more natural sound expression can be performed.

### BRIEF DESCRIPTION OF THE DRAWINGS

FIG. 1 is a block diagram showing a non-limiting example of the internal configuration of a game apparatus 2;

FIG. 2 illustrates a non-limiting example of a game screen according to an exemplary embodiment;

FIG. 3 is a schematic overhead view of a non-limiting example of a virtual game space;

FIG. 4 is a diagram illustrating a non-limiting example of a waterfall sound source object;

FIG. 5 is a diagram illustrating a non-limiting example of a hiding determination region;

FIG. 6 is a non-limiting example diagram for describing the hiding determination region;

FIG. 7 is a non-limiting example diagram for describing the waterfall sound source object;

FIG. 8 is a non-limiting example diagram for describing the waterfall sound source object;

FIG. 9 is a non-limiting example diagram for describing the hiding determination region;

FIG. 10 illustrates a memory map showing a non-limiting example of various kinds of data stored in a storage section 84;

FIG. 11 is a non-limiting example flowchart showing the details of game processing according to the exemplary embodiment; and

FIG. 12 is a non-limiting example flowchart showing the details of the game processing according to the exemplary embodiment.

### DETAILED DESCRIPTION OF NON-LIMITING EXAMPLE EMBODIMENTS

Hereinafter, an exemplary embodiment will be described.

### [Hardware Configuration of Information Processing Apparatus]

First, an information processing apparatus for executing information processing according to the exemplary embodiment will be described. The information processing apparatus is, for example, a smartphone, a stationary or hand-held game apparatus, a tablet terminal, a mobile phone, a personal computer, a wearable terminal, or the like. In addition, the information processing according to the exemplary embodiment can also be applied to a game system that includes the above game apparatus or the like and a predetermined server. In the exemplary embodiment, a stationary game apparatus (hereinafter, referred to simply as a game apparatus) will be described as an example of the information processing apparatus. In addition, game processing will be described as an example of the information processing.

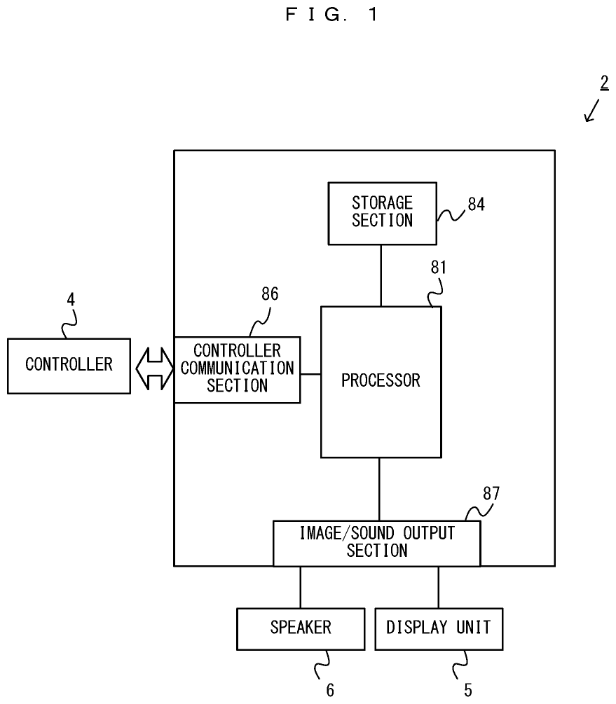

FIG. 1 is a block diagram showing an example of the internal configuration of a game apparatus 2 according to the exemplary embodiment. The game apparatus 2 includes a processor 81. The processor 81 is an information processing section for executing various types of information processing to be executed by the game apparatus 2. For example, the processor 81 may be composed only of a CPU (Central Processing Unit), or may be composed of a SoC (System-on-a-chip) having a plurality of functions such as a CPU function and a GPU (Graphics Processing Unit) function. The processor 81 performs the various types of information processing by executing an information processing program (e.g., a game program) stored in a storage section 84. The storage section 84 may be, for example, an internal storage medium such as a flash memory and a dynamic random access memory (DRAM), or may be configured to utilize an external storage medium mounted to a slot that is not shown, or the like.

The game apparatus 2 also includes a controller communication section 86 for the game apparatus 2 to perform wired or wireless communication with a controller 4. Although not shown, the controller 4 is provided with various buttons such as a cross key and A, B, X, and Y buttons, an analog stick, etc.

Moreover, a display unit 5 (for example, a liquid crystal monitor, or the like) and a speaker 6 are connected to the game apparatus 2 via an image/sound output section 87. The processor 81 outputs an image generated, for example, by executing the above information processing, to the display unit 5 via the image/sound output section 87. In addition, the processor 81 outputs a generated sound (signal) to the speaker 6 via the image/sound output section 87.

### [Outline of Processing in Exemplary Embodiment]

Next, an outline of sound processing according to the exemplary embodiment will be described. First, in the exemplary embodiment, a game in which a player character object (hereinafter, referred to as player character) is operated in a virtual three-dimensional game space (hereinafter, referred to as virtual game space) is assumed. The processing related to sound is also performed on the assumption that the game is played in the virtual three-dimensional space. That is, a volume and a filter amount are set on the basis of the positional relationship between a sound source object (hereinafter, simply referred to as sound source) and a virtual microphone placed in the virtual three-dimensional space. In the exemplary embodiment, a setting process that takes attenuation based on distance and a hiding degree into account is performed. Specifically, first, a volume and a filter amount are set such that the volume of a sound heard from a sound source farther away from the virtual microphone is smaller than that from a sound source near the virtual microphone. That is, a process in which the volume is attenuated according to distance is performed. In the exemplary embodiment, this process is referred to as “distance attenuation process”. Furthermore, when a sound source is hidden when viewed from the virtual microphone, for example, a volume and a filter amount are set for a sound that is heard from a next room across a wall, such that the sound is muffled. Such a simulation in which the sound is muffled is referred to as “hiding effect process” in the exemplary embodiment. In addition, other processes such as adding reflection and reverberation (reverb) effects to a sound, for example, in a closed space, such as in a cave are also performed. Thus, a sound emitted from a virtual sound source placed in the three-dimensional space is processed as described above, and then a sound to be finally outputted to the speaker 6 or the like is generated.

The processing described in the exemplary embodiment relates to such sound processing. More specifically, this processing is sound processing that assumes the case where the sound source to be targeted is one sound source having a huge scale in relation to the player character or the virtual microphone, such as a “waterfall”, and particularly relates to a hiding effect process for such a huge sound source.

As for the above hiding effect process, in the exemplary embodiment, a determination as to “whether or not the sound source is hidden” is performed by a so-called “ray casting” method. Specifically, first, a transparent straight line (ray) is cast from the virtual microphone toward a point, closest to the virtual microphone (hereinafter, referred to as closest point), on the sound source to be targeted for the determination. When the straight line is blocked by a predetermined obstacle object (hereinafter, referred to as obstacle), it is determined that the sound source is “hidden”. In other words, whether or not any obstacle exists on the straight line is determined, and when an obstacle exists, it is determined that the sound source is hidden.

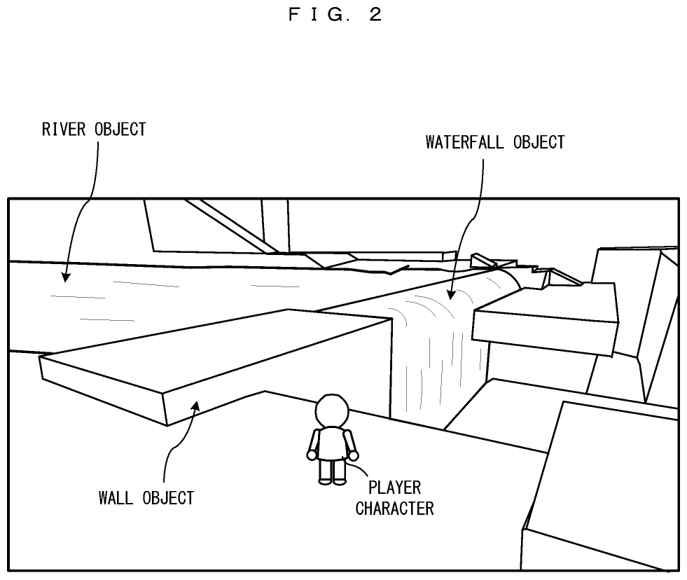

Here, a situation shown in a game screen example in FIG. 2 is assumed. In FIG. 2, a third-person-view game screen is displayed. In addition, a waterfall object is displayed in the forward direction of the player character. The waterfall object is assumed to be huge compared to the player character. In FIG. 2, the player character is at a position where the player character can look down at the waterfall. As for the front surface of the waterfall object (hereinafter, referred to as waterfall surface), the situation in FIG. 2 is a situation in which a part of the waterfall surface on the near side of the screen is hidden by a wall object and cannot be seen, but most of the waterfall surface can be seen. In addition, an area around the waterfall object is assumed to be an open space (outdoors).

Here, supplementary description will be given regarding the waterfall object and a sound source object associated therewith (hereinafter, referred to as waterfall sound source object). In the exemplary embodiment, an invisible waterfall sound source object is placed at the same position as the waterfall object. The waterfall sound source object is a cube or rectangular parallelepiped object that encompasses the entire waterfall object. In the exemplary embodiment, the waterfall sound source object is assumed to be a rectangular parallelepiped object that has an elongated shape and the same size as the waterfall object.

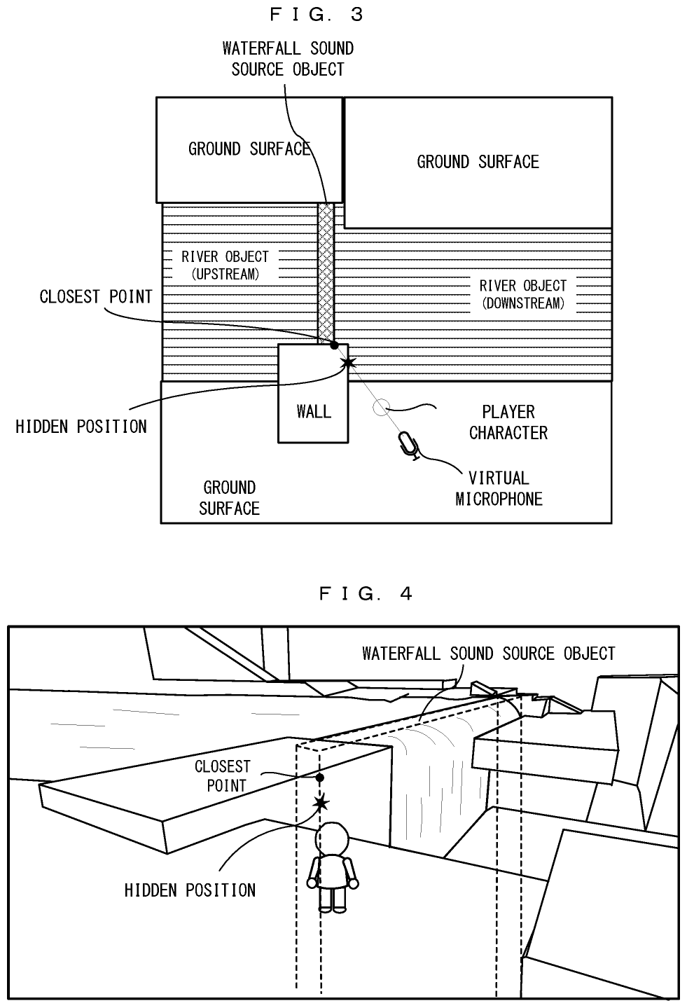

It is considered to perform the above-described hiding determination on the assumption that the above-described waterfall sound source object exists. Specifically, it is assumed that, for the hiding determination, a straight line is cast from the virtual microphone toward the closest point on the waterfall sound source object. In the exemplary embodiment, it is also assumed that the position of the virtual microphone is the same as that of the virtual camera. Therefore, the hiding determination is practically equivalent to determining whether or not the above closest point is “visible” from the virtual camera. In this case, as shown in FIG. 3 and FIG. 4, the closest point on the waterfall sound source object as viewed from the virtual microphone has a positional relationship in which the closest point is hidden by the wall object.

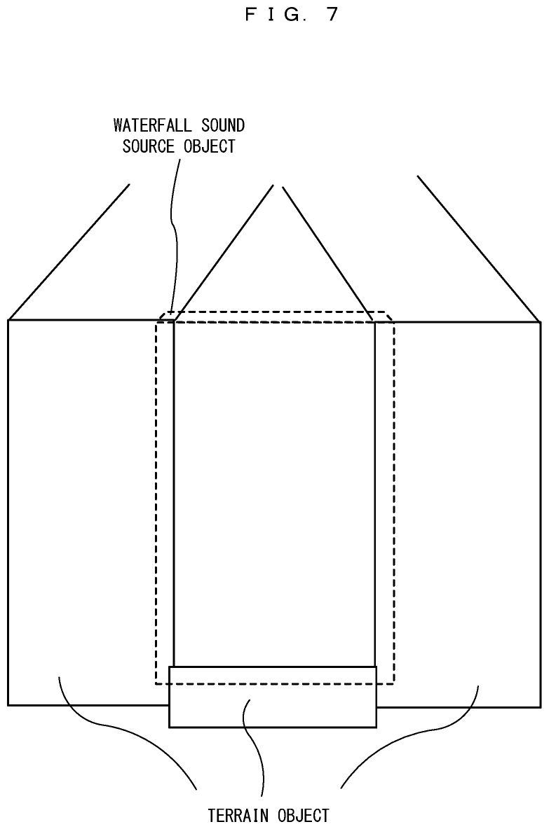

In the above positional relationship, the straight line cast from the virtual microphone is blocked by the wall object, and it is determined that the waterfall sound source object is hidden. Meanwhile, most of the waterfall surface can be seen as shown in FIG. 2. That is, for the waterfall sound source object, even though the waterfall sound source object has a portion that is not hidden on the screen, it is determined that the entire waterfall sound source object is hidden. As a result, the sound of the waterfall sound source object (hereinafter, referred to as waterfall sound) is expressed as a muffled sound. However, if the sound of the waterfall is heard so as to be muffled even though most of the waterfall surface can be seen as described above, the player may be given an uncomfortable feeling for the appearance of the displayed screen or a feeling of discrepancy between visual and auditory senses. In other words, there may be a situation in which the player is given an uncomfortable feeling if the entire sound source object is treated as being hidden due to the closest point, which is merely a part of the huge sound source object such as a waterfall, being hidden by an obstacle when viewed from the virtual microphone. The shapes of the waterfall sound source object and the wall are not limited to shapes that are in contact with each other as in FIG. 2 or FIG. 3, and may be set such that the waterfall sound source object having a large shape is set and partially embedded in the wall as in FIG. 7 described later. Alternatively, the shapes of the waterfall sound source object and the wall may be set such that the wall is partially embedded in the waterfall sound source object. In such a case as well, the closest point is hidden by the wall in the situation in FIG. 2.

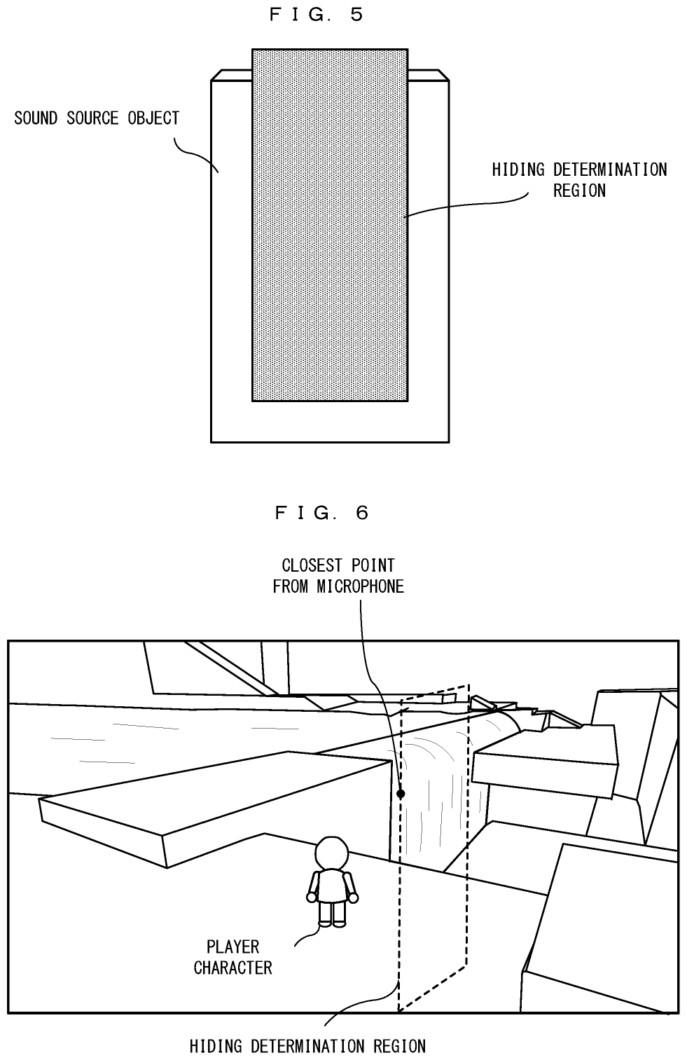

Therefore, in the exemplary embodiment, the following sound control processing is performed. First, for the waterfall sound source object, a “hiding determination region” used for the hiding determination is generated. FIG. 5 shows an example of the waterfall sound source object and the hiding determination region. FIG. 5 shows a waterfall sound source object having an elongated rectangular parallelepiped shape and a hiding determination region having an elongated planar shape. The hiding determination region is placed at the same position as the front surface of the waterfall sound source object, that is, the surface on the water surface side of the waterfall. As for this placement position, as long as the hiding determination region is placed along the front surface of the waterfall sound source object, the hiding determination region may be placed at a position slightly displaced backward or forward from the front surface of the waterfall sound source object. In addition, in terms of the size of the hiding determination region, basically, the hiding determination region has a shape based on the shape of the front surface of the waterfall sound source object, but has a horizontal width smaller than the width of the sound source object. That is, the hiding determination region has a shape obtained by slightly reducing the horizontal width of the front surface of the sound source object. Furthermore, the lower side of the hiding determination region has a shape obtained by slightly shifting the lower side of the sound source object in the upward direction. In other words, the hiding determination region has a shape in which the vertical width of the hiding determination region is slightly smaller than that of the sound source object by a portion below the vertical width of the hiding determination region. On the other hand, the upper side of the hiding determination region has a shape in which the hiding determination region slightly protrudes upward from the upper side of the sound source object. In other words, the hiding determination region is shaped such that a portion thereof is outside the front surface of the waterfall sound source object. In general, the hiding determination region has a shape that is smaller than the shape of the front surface of the sound source object and slightly protrudes upward from the upper side of the sound source object. In the exemplary embodiment, the above hiding determination is performed using the hiding determination region having such a shape. Specifically, whether or not the sound source object is hidden is determined by determining whether or not a straight line extending from the virtual microphone to the closest point on the hiding determination region is blocked.

FIG. 6 shows the positional relationship of the hiding determination region in the situation in FIG. 2 above. In FIG. 6, the hiding determination region is shown by a broken line. As described above, the horizontal width of the hiding determination region is smaller than that of the sound source object. Therefore, a straight line extending from the virtual microphone located at the position of the head of the player character to the closest point on the hiding determination region can reach the closest point without being blocked by a wall object or the like in the middle. As a result, it is determined that the waterfall sound source object is “not hidden”.

As described above, in the exemplary embodiment, the width of the hiding determination region is smaller than that of the sound source object. Accordingly, in the case where the virtual microphone is located in the vicinity of the left, right, or lower side of the waterfall sound source object, it is made easier to determine that the waterfall sound source object is “not hidden”. The above example illustrates a case where the sizes of the invisible waterfall sound source object and the visible waterfall object are the same, but the size of the waterfall sound source object may be set to be larger than that of the waterfall object such that the waterfall sound source object can cover the entire waterfall object. In addition, it is generally considered that there is often some kind of terrain on the left, right, and lower sides of the waterfall. Due to these, as for the placement of the waterfall sound source object, for example, a placement relationship shown in FIG. 7 may be established. FIG. 7 shows a placement relationship in which left, right, and lower end portions of the waterfall sound source object are embedded in a terrain object. In such a case, when the hiding determination is performed using the closest point on the waterfall sound source object from the virtual microphone, the position at which the waterfall sound source object is embedded in such terrain may be the above closest point. As a result, the closest point is inevitably hidden by the obstacle, even though most of the waterfall surface can be seen, and it is determined that the waterfall sound source object is “hidden”. In this regard, by using the hiding determination region as in the exemplary embodiment, it is made easier to determine that the waterfall sound source object is “not hidden”. Accordingly, the waterfall sound can be inhibited from being unnaturally muffled even in the situation in FIG. 2 above.

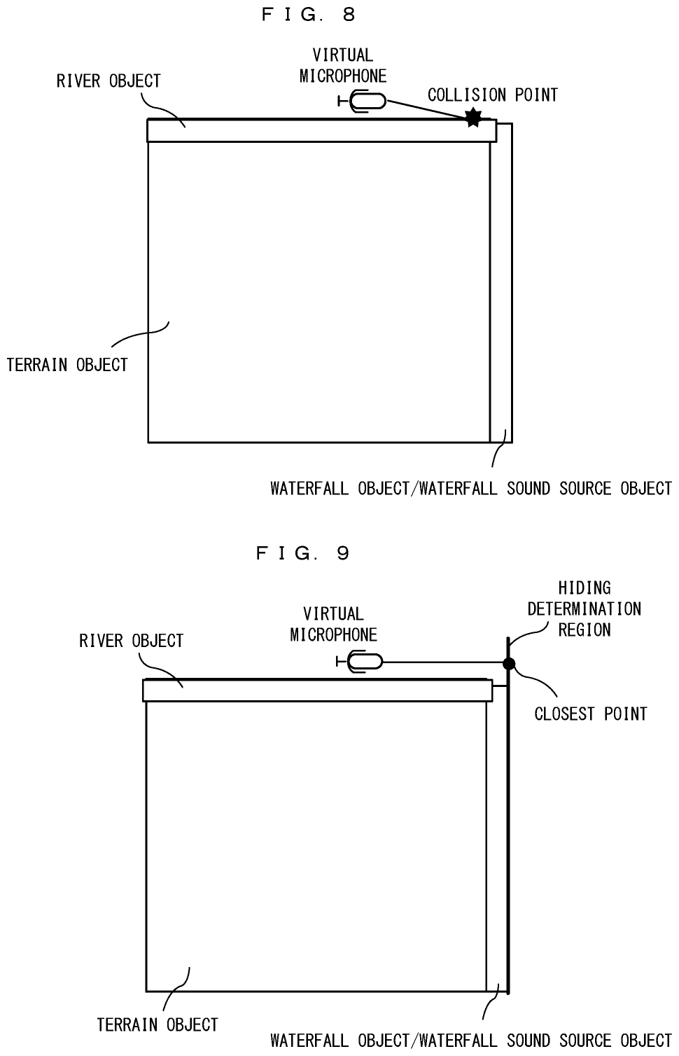

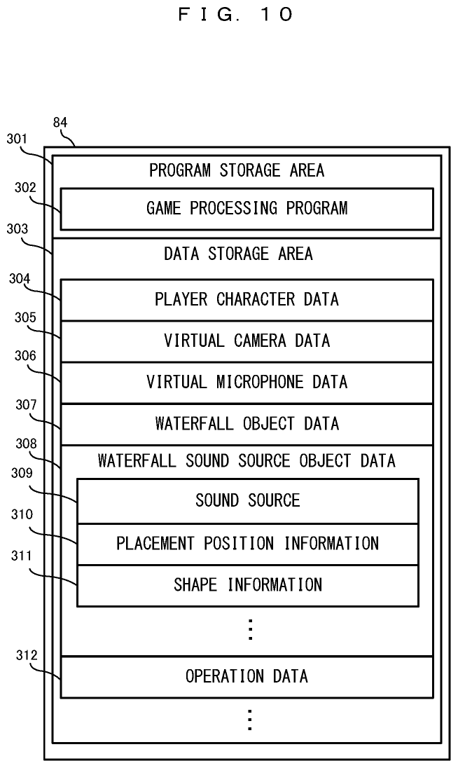

Next, the reason for and the effect by shaping an upper end portion of the hiding determination region so as to slightly protrude will be described. First, a situation shown in FIG. 8 is assumed. FIG. 8 is a schematic diagram showing a cross-section of the waterfall object and the terrain object and the river object adjacent thereto as viewed from the lateral side. In FIG. 8, it is assumed that the player character and the virtual microphone are located at a predetermined position on the upstream side of the waterfall, for example, on a ground surface portion that is close to the waterfall surface to some extent and that is near the river. In other words, this situation is a situation in which the virtual microphone is located on the back side of the waterfall so as to be close to the upper end of the waterfall to some extent. In the case of such a positional relationship, if the hiding determination is performed using the closest point on the waterfall sound source object with respect to the virtual microphone, a situation in which a straight line extending from the virtual microphone is blocked by the river object or the like as shown in FIG. 8 may occur. As a result, it is determined that the waterfall sound source object is hidden, and the waterfall sound is expressed as a muffled sound. In this case, since the situation is a situation in which the waterfall surface is not directly visible on the game screen but the player character is located near the upper end of the waterfall, an uncomfortable feeling may be given to the player due to the sound of the waterfall being heard as a muffled sound. Therefore, in the exemplary embodiment, the shape of the hiding determination region is a shape obtained by slightly extending the waterfall sound source object in the upward direction as described above. Accordingly, as shown in FIG. 9, it is made difficult for a straight line from the virtual microphone to the closest point on the hiding determination region to be blocked. As a result, it is determined that the waterfall sound source object is “not hidden”, and the waterfall sound can be inhibited from being expressed as a muffled sound. In other words, it can also be said that the shape in which the hiding determination region slightly protrudes upward is a shape that makes it difficult to determine that the waterfall sound source object is “hidden”.

By performing the hiding determination using the closest point on the above-described hiding determination region, it is possible to perform a more natural expression of the waterfall sound that gives a less uncomfortable feeling for the contents displayed as a game image.

### [Details of Game Processing of Exemplary Embodiment]

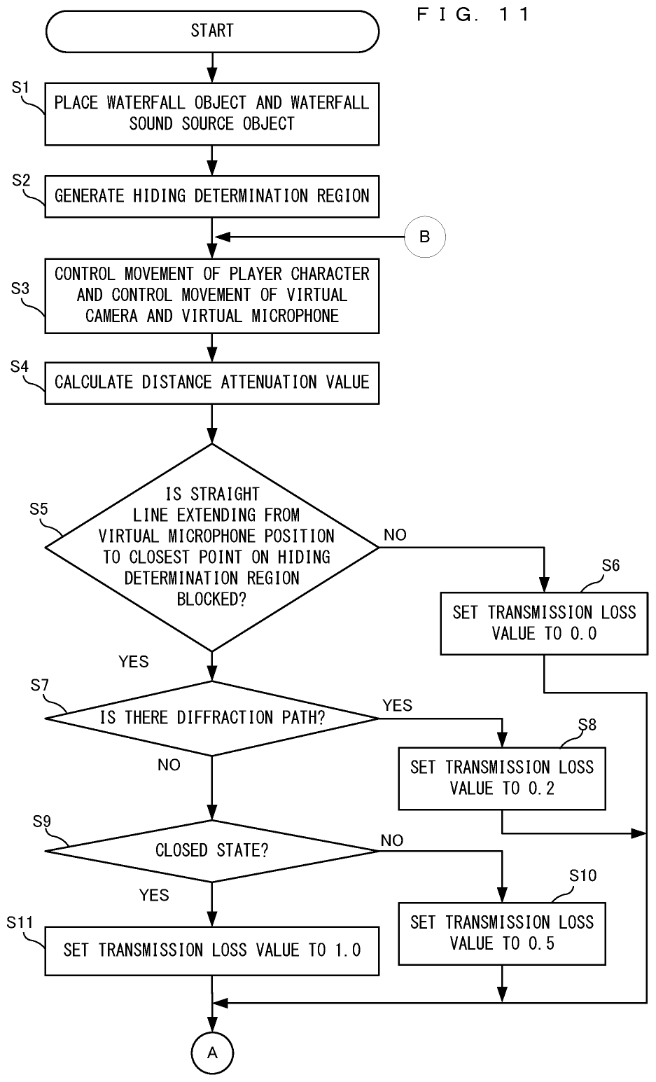

Next, the game processing in the exemplary embodiment will be described in more detail with reference to FIG. 10 to FIG. 12.

### [Data to be Used]

First, various kinds of data to be used in the game processing will be described. FIG. 10 illustrates a memory map showing an example of various kinds of data stored in the storage section 84 of the game apparatus 2. The storage section 84 includes a program storage area 301 and a data storage area 303. In the program storage area 301, a game processing program 302 is stored. In addition, in the data storage area 303, player character data 304, virtual camera data 305, virtual microphone data 306, waterfall object data 307, waterfall sound source object data 308, operation data 312, etc., are stored.

The game processing program 302 is a program for executing the game processing including the above-described sound control.

The player character data 304 is data regarding the above player character. The player character data 304 includes information indicating the position and the orientation of the player character in the virtual space, information indicating the appearance of the player character, etc.

The virtual camera data 305 is data that specifies the current position, orientation, angle of view, etc., of the virtual camera. The contents of the virtual camera data 305 are set on the basis of the position of the player character and the content of an operation performed by the player.

The virtual microphone data 306 is data for indicating the position of the virtual microphone, and includes at least information indicating this position.

The waterfall object data 307 is data regarding the above waterfall object. The waterfall object data 307 includes information indicating the position at which the waterfall object is placed in the virtual space, and the size, shape, appearance, etc., of the waterfall object.

The waterfall sound source object data 308 is data regarding the above waterfall sound source object. The waterfall sound source object data 308 includes at least a sound source 309, placement position information 310, and shape information 311. The sound source 309 is sound data that is the source of sounds to be reproduced. The placement position information 310 is data indicating the placement position of the waterfall sound source object in the virtual game space. The shape information 311 is information indicating the shape and the size of the waterfall sound source object. The shape information 311 may be information directly indicating the shape, or may be information indicating the relative position and size magnification relative to the shape of the waterfall object.

The operation data 312 is data indicating the content of an operation performed on the controller 4. In the exemplary embodiment, the operation data 309 includes data indicating pressed states of the buttons such as the cross key or an input state to the analog stick provided to the controller 4. The content of the operation data 312 is updated in predetermined cycles on the basis of a signal from the controller 4.

In addition, various kinds of data to be used in the game processing, such as various objects other than those described above and various sound source objects other than the waterfall sound source, are stored in the storage section 84.

### [Details of Processing Executed by Processor 81]

Next, the game processing according to the exemplary embodiment will be described in detail. Here, processing regarding the above-described control of a sound related to the waterfall sound source object will be mainly described, other game processing will be briefly described, and the detailed description thereof is omitted.

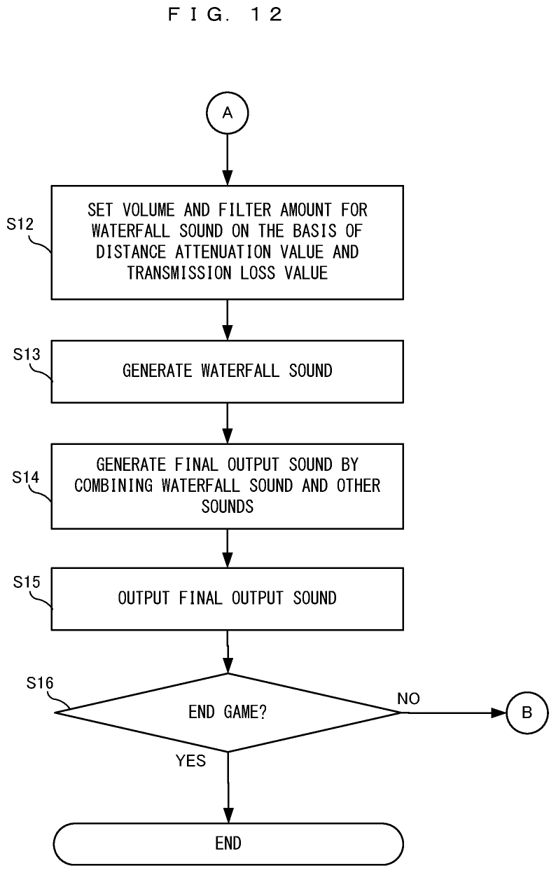

FIG. 11 and FIG. 12 are flowcharts showing the details of the game processing according to the exemplary embodiment. In the exemplary embodiment, the flowcharts are realized by one or more processors reading and executing the above program stored in one or more memories. A process loop of steps S3 to S16 shown in these drawings is repeatedly executed every frame period. In addition, this flowchart is merely an example of the processing. Therefore, the order of each process step may be changed as long as the same result is obtained. In addition, the values of variables and thresholds used in determination steps are also merely examples, and other values may be used as necessary.

In FIG. 11, first, in step S1, the processor 81 places the waterfall object and the waterfall sound source object in the virtual space. Here, both objects are placed at the same position.

Next, in step S2, the processor 81 generates the hiding determination region on the basis of the shape of the front surface side of the waterfall sound source object. For example, the processor 81 generates, as the hiding determination region, a surface-shaped region obtained by setting the scales in the horizontal direction and the downward direction of the shape of the front surface side of the waterfall sound source object to 0.75 times and the scale in the upward direction of the shape of the front surface side of the waterfall sound source object to 1.1 times. Then, the processor 81 places the hiding determination region along the front surface of the waterfall sound source object.

The processes in steps S1 and S2 above may be performed at any timing. For example, the data of the waterfall object and the waterfall sound source object may be loaded into the storage section 84 at the timing when the waterfall object becomes included in the imaging range of the virtual camera as the player character moves, or at a timing shortly before that timing. Then, at this timing, the waterfall object and the waterfall sound source object generated on the basis of this data may be placed in the virtual space. Furthermore, the above hiding determination region may be generated in conjunction with the placement of the waterfall sound source object.

Next, in step S3, the processor 81 controls the movement of the player character on the basis of the operation data 312. Furthermore, the processor 81 determines the positions of the virtual camera and the virtual microphone on the basis of the position of the player character after movement. For example, a position away by a predetermined distance behind the player character is determined as the position of the virtual camera. In addition, a position that is the same as that of the virtual camera is determined as the position of the virtual microphone. Then, the processor 81 moves the virtual camera and the virtual microphone to the determined position.

Next, in step S4, the processor 81 calculates a distance attenuation value for the waterfall sound. Specifically, the processor 81 calculates an attenuation value for the volume of the waterfall sound on the basis of the linear distance between the virtual microphone and the closest point on the waterfall sound source object. The final output volume of the waterfall sound is determined on the basis of the distance attenuation value in a process described later. In the exemplary embodiment, the distance attenuation value is calculated such that the volume is decreased as the distance increases, that is, as the closest point becomes farther away from the virtual microphone.

Next, a hiding effect process is performed. In this process, a “transmission loss value” is obtained. The transmission loss value is a value indicating a hiding degree, i.e., how much of an emitted sound is blocked. In the exemplary embodiment, the transmission loss value is assumed to be a value within the range of “0.0” to “1.0”. In addition, a value of “1.0” indicates that the hiding degree is high. Finally, a process in which the volume attenuated on the basis of the distance attenuation value is further attenuated on the basis of the transmission loss value, is performed. Specifically, the following process is performed.

First, in step S5, the processor 81 performs a hiding determination for determining whether or not the current situation is a situation in which the sound emitted from the sound source reaches the virtual microphone in a linear manner. Specifically, the processor 81 determines whether or not a straight line extending from the position of the virtual microphone to the hiding determination region is blocked by any obstacle. In other words, the processor 81 determines whether or not any obstacle exists on the straight line. As a result of the determination, if the straight line is not blocked (NO in step S5), in step S6, the processor 81 determines the transmission loss value to be “0.0”. Then, the processor 81 advances the processing to step S12 described later.

On the other hand, if the above straight line is blocked (YES in step S5), in step S7, the processor 81 searches for a diffraction path and determines whether or not there is any diffraction path. That is, even if the sound does not reach the virtual microphone in a linear manner, the processor 81 determines whether or not there is any path in which the sound reaches the virtual microphone so as to bypass the obstacle. Therefore, first, the processor 81 searches for a diffraction path in which the sound emitted from the sound source travels around in the virtual three-dimensional space in order for this sound to reach the virtual microphone. The searching method for the diffraction path may be any method. For example, it is determined whether or not a path in which the sound can reach the virtual microphone within a predetermined distance exists as a result of the search. As a result of the search, if such a diffraction path exists, it is determined that there is a diffraction path (YES in step S7). In this case, in step S8, the processor 81 determines the transmission loss value to be “0.2”. Then, the processor 81 advances the processing to step S12 described later.

On the other hand, if there is no diffraction path (NO in step S7), in step S9, the processor 81 determines whether or not the positional relationship between the virtual microphone and the hiding determination region is a “closed state”. In the exemplary embodiment, the closed state is a state where either the virtual microphone or the waterfall sound source object and the hiding determination region are “indoors” and the other is “outdoors”. For example, a situation in which the player character and the virtual microphone are in a hut near the waterfall and the interior of the hut is a closed space with closed doors and windows is a situation in which the player character and the virtual microphone are indoors. The waterfall outside the hut is outdoors. As described above, a state where only either the virtual microphone or the waterfall sound source object and the hiding determination region are indoors is the closed state. In this example, since a huge sound source object that is the “waterfall” is exemplified, it is difficult to imagine a state where the “waterfall” is indoors, but a state with a relationship in which the sound source is indoors and the player character is outdoors can be the closed state. In other words, a state with a relationship in which both the virtual microphone and the sound source are in the same indoor space or are outdoors is not the closed state, and a state where one of the virtual microphone and the sound source is indoors and the other is outdoors, or a state where the virtual microphone and the sound source are in different indoor spaces, for example, one of the virtual microphone and the sound source is in an indoor space A and the other is in a different indoor space B, can be the closed state.

Any method can be used as the determination method for the closed state as described above, but in the exemplary embodiment, for example, the following determination is performed. First, the virtual space is divided in advance into cubes of a predetermined size, and each cube is provided with indoor/outdoor information indicating whether the space thereof is “indoors” or “outdoors”. Next, whether or not the position of the player character is indoors is determined on the basis of the current position of the player character and the indoor/outdoor information. Next, whether or not the position of the closest point is outdoors is determined on the basis of the position of the closest point on the hiding determination region and the indoor/outdoor information. Then, if the indoor/outdoor information corresponding to the position of the player character and the indoor/outdoor information corresponding to the position of the closest point are different from each other, it is determined that the positional relationship is the closed state.

As a result of the determination in step S9 above, if the positional relationship is the above closed state (YES in step S9), the processor 81 determines the transmission loss value to be “1.0” in step S1i. On the other hand, if the positional relationship is not the closed state (NO in step S9), the processor 81 determines the transmission loss value to be “0.5” in step S10.

Next, in step S12 in FIG. 12, the processor 81 determines a volume and a filter amount for the waterfall sound on the basis of the distance attenuation value and the transmission loss value. Specifically, first, the processor 81 sets a provisional volume and a provisional filter amount for the waterfall sound on the basis of the distance attenuation value. For example, the provisional volume and the provisional filter amount may be determined using a predetermined graph in which the volume decreases and the filter amount increases as the distance attenuation value increases. Accordingly, the volume is attenuated in accordance with the distance between the virtual microphone and the waterfall sound source object. Furthermore, the processor 81 sets a final volume and filter amount for the waterfall sound by further attenuating the provisional volume and the provisional filter amount on the basis of the transmission loss value. For example, the final volume and filter amount for the waterfall sound may be determined using a graph in which the volume decreases and the filter amount increases as the transmission loss value increases. Accordingly, the hidden situation of the waterfall sound source object based on the hiding determination region as described above is reflected in the volume and the filter amount for the waterfall sound.

Next, in step S13, the processor 81 generates the waterfall sound on the basis of the set volume and filter amount. At this time, the processor 81 also calculates a localization of the waterfall sound on the basis of the positional relationship between the virtual microphone and the waterfall sound source object. Then, the processor 81 generates the waterfall sound such that the localization is reflected.

Next, in step S14, the processor 81 generates sounds related to sound sources other than the waterfall sound source object as appropriate. Then, the processor 81 generates a final output sound by combining the above waterfall sound and the other sounds.

Next, in step S15, the processor 81 outputs the above output sound to the speaker 6 or the like. In conjunction with this sound output, a process of outputting a game image generated on the basis of the virtual camera is also performed, although the derailed description thereof is omitted.

Next, in step S16, the processor 81 determines whether a condition for ending the game processing has been satisfied. For example, the processor 81 determines whether a game end instruction operation has been performed by the player. If this condition has not been satisfied (NO in step S16), the processor 81 returns to step S3 and repeats the processing. On the other hand, if this condition has been satisfied (YES in step S16), the processor 81 ends the game processing.

This is the end of the detailed description of the game processing according to the exemplary embodiment.

As described above, in the exemplary embodiment, when the closest point on the sound source object itself is used for the above hiding determination, the determination of the hidden situation of the sound source object is performed using the hiding determination region having the above shape in which the hiding determination region is narrower than the front surface of the waterfall sound source object. Accordingly, an unnatural determination result that the entire waterfall sound source object is hidden can be inhibited from being obtained in a situation in which an end portion of the waterfall sound source object is locally hidden.

The upper side of the hiding determination region is shaped so as to protrude outside the front surface of the waterfall sound source object. Accordingly, for example, when the virtual microphone is on the upstream side of the waterfall, it is made easier to determine that the waterfall sound source object is “not hidden”. Although the above example illustrates the shape in which the hiding determination region protrudes upward, the direction in which the hiding determination region protrudes is not limited to the upward direction, and the hiding determination region may be shaped so as to protrude outside the front surface of the waterfall sound source object in another direction. In this case as well, for example, when the virtual microphone is near the protruding side, it is made easier to determine that the waterfall sound source object is “not hidden”, as in the above.

### Modifications

In the above embodiment, the case where the virtual microphone is located at the same position as the virtual camera has been described as an example of the position of the virtual microphone. As for the hiding determination, the example in which the hiding determination is performed using the straight line connecting the position of the virtual microphone and the closest point on the hiding determination region, has been described. In other words, the straight line connecting the virtual camera and the closest point on the hiding determination region is used. In this regard, in another exemplary embodiment, the hiding determination may be performed with a position different from the virtual camera and the virtual microphone, as a “reference point”. That is, a position used for the hiding determination and a position used for calculation of the above distance attenuation value, etc., may be different from each other. In other words, a separate virtual microphone dedicated for the hiding determination is prepared. For example, a position obtained by changing a position that is the midpoint of the head of the player character to a position having the same height as the virtual camera may be used as the above reference point. Then, it may be determined whether or not an obstacle exists on a straight line extending from the reference point to the closest point on the hiding determination region.

In the above embodiment, the example in which the hiding determination region is placed along the front surface of the waterfall sound source object has been described. In another exemplary embodiment, the hiding determination region may be placed along another surface of the waterfall sound source object other than the front surface. In this case as well, the shape of the hiding determination region may be determined on the basis of the shape of the other surface.

In the above embodiment, as for the waterfall sound source object, the example in which data that defines the shape, etc., of the waterfall sound source object is prepared in advance has been described. In this regard, in another exemplary embodiment, for example, at the timing when the data of the waterfall object is read, the above waterfall sound source object may be generated on the basis of the shape of the waterfall object, and may be placed at the same position as the waterfall object. The above hiding determination region may be generated on the basis of the shape of the generated waterfall sound source object. In still another exemplary embodiment, a determination region having the same shape as the sound source object may be generated separately from the sound source object. Then, this determination region may be used for purposes other than the above hiding determination, such as calculation of the above distance attenuation value and localization.

In the above embodiment, the “waterfall” has been exemplified as the sound source for which the above hiding determination region is used for the hiding determination. The present disclosure is not limited thereto, and if the above closest point on the sound source object is used for the hiding determination, the processing according to the exemplary embodiment is effective for general huge sound source objects that are unnaturally determined to be hidden as a whole. The processing can also be applied to, for example, a large “river”, etc.

In the above embodiment, as for the shape of the hiding determination region, the shape in which the horizontal width and the lower side portion of the vertical width are narrower than those of the front surface of the waterfall sound source object and the upper side portion protrudes from the front surface, has been exemplified. In this regard, in another exemplary embodiment, the hiding determination region may have a shape having only one of the above features, depending on the game content, map design, etc. For example, the hiding determination region may have a shape in which the horizontal width and the lower side portion of the vertical width thereof are narrower but the upper side portion thereof does not protrude. Alternatively, the hiding determination region may have a shape in which the upper side portion thereof protrudes but the horizontal width and the lower side portion of the vertical width thereof are the same as those of the entire surface of the waterfall sound source object.

In the above embodiment, the process in which the transmission loss value is set to any of the four values “0.0”, “0.2”, “0.5”, and “1.0” has been exemplified. In this regard, in a situation in which the transmission loss value transitions as the player character moves, the above volume and filter amount may be calculated such that the intermediate values of these values are interpolated. For example, the case of changing from the situation in which the transmission loss value is “0.2” to a situation in which the transmission loss value is “0.5” due to the movement of the player character, is assumed. In this case, the volume and the filter amount may be gradually changed, while interpolating the transmission loss value, for example, over a time of about 0.7 seconds, instead of immediately changing the volume and the filter amount from the volume and the filter amount when the transmission loss value is “0.2” to the volume and the filter amount when the transmission loss value is “0.5”. Accordingly, giving an uncomfortable feeling to the player by a rapid change in the way the waterfall sound is heard can be suppressed.

In the above embodiment, the case where the series of processes according to the game processing are performed in the single game apparatus 2 has been described. However, in another embodiment, the above series of processes may be performed in an information processing system that includes a plurality of information processing apparatuses. For example, in an information processing system that includes a terminal side apparatus and a server side apparatus capable of communicating with the terminal side apparatus via a network, a part of the series of processes may be performed by the server side apparatus. Alternatively, in an information processing system that includes a terminal side apparatus and a server side apparatus capable of communicating with the terminal side apparatus via a network, a main process of the series of the processes may be performed by the server side apparatus, and a part of the series of the processes may be performed by the terminal side apparatus. Still alternatively, in the information processing system, a server side system may include a plurality of information processing apparatuses, and a process to be performed in the server side system may be divided and performed by the plurality of information processing apparatuses. In addition, a so-called cloud gaming configuration may be adopted. For example, the game apparatus 2 may be configured to send operation data indicating a player's operation to a predetermined server, and the server may be configured to execute various kinds of game processing and stream the execution results as video/audio to the game apparatus 2.

While the present disclosure has been described in detail, the foregoing description is in all aspects illustrative and not restrictive. It is to be understood that numerous other modifications and variations can be devised without departing from the scope of the present disclosure.

What is claimed is:

1. A computer-readable non-transitory storage medium having stored therein a game program causing a computer of an information processing apparatus to:
control a position of a virtual microphone in a virtual space;
for a virtual first sound source placed in the virtual space and associated with a first sound,
set a volume of the first sound such that the volume of the first sound is attenuated in accordance with a distance between a first determination region having a predetermined shape and the virtual microphone,
perform a hiding determination as to the first sound source on the basis of a positional relationship between the virtual microphone and a second determination region having a shape different from that of the first determination region, the shape of the second determination region satisfying at least that a part thereof is outside the first determination region or that a width thereof is smaller than that of the first determination region, and
set the volume of the first sound such that the volume of the first sound is further attenuated when the first sound source is hidden, on the basis of a result of the hiding determination; and
output the first sound on the basis of the set volume.

2. The storage medium according to claim 1, wherein the distance between the first determination region and the virtual microphone is a distance between a point, closest to the virtual microphone, on the first determination region and the position of the virtual microphone.

3. The storage medium according to claim 2, wherein the game program causes the computer to:
determine whether or not an obstacle object exists between a reference point based on the position of the virtual microphone and a point, closest to the reference point, on the second determination region in the virtual space; and
when it is determined that the obstacle object exists, determine that the first sound source is hidden.

4. The storage medium according to claim 2, wherein the game program causes the computer to:
determine whether or not an obstacle object exists between a reference point based on the position of the virtual microphone and a point, closest to the reference point, on the second determination region in the virtual space;
when it is determined that the obstacle object exists, further determine whether or not a path bypassing the obstacle object within a predetermined range exists between the virtual microphone and a point, closest to the virtual microphone, on the second determination region;
when it is determined that the path exists, determine that the first sound source is hidden to a first degree;
when it is determined that the path does not exist, determine that the first sound source is hidden to a second degree higher than the first degree; and
set the volume such that the volume is attenuated on the basis of the determined hiding degree.

5. The storage medium according to claim 4, wherein the game program causes the computer to:
when it is determined that the bypassing path does not exist, further determine whether or not a position of the reference point and the point closest to the reference point are positions indicating indoor spaces preset in the virtual space; and
when either one of the position of the reference point and the point closest to the reference point is the position indicating the indoor space, determine that the first sound source is hidden to a third degree higher than the second degree.

6. The storage medium according to claim 3, wherein
the first determination region has a three-dimensional shape having a plurality of surfaces, and
the second determination region has a planar shape along one of the surfaces of the first determination region.

7. The storage medium according to claim 3, wherein
an object corresponding to the first sound source is placed in the virtual space,
the first determination region is placed along the object corresponding to the first sound source, and
the second determination region has a shape in which the second determination region has a smaller width than the first determination region and protrudes toward a position where the object is not placed in the virtual space.

8. The storage medium according to claim 3, wherein
a waterfall object corresponding to the first sound source is placed in the virtual space,
the first determination region is placed along the waterfall object, and
the second determination region is placed along a surface, on a water surface side of the waterfall object, of the first determination region and has a planar shape in which the second determination region has a smaller width in a width direction of the waterfall object than the first determination region and protrudes toward an upper side of the waterfall object.

9. The storage medium according to claim 6, wherein the game program further causes the computer to generate the second determination region on the basis of a shape of the first determination region.

10. The storage medium according to claim 8, wherein the game program further causes the computer to:
generate the first determination region on the basis of a shape of the waterfall object; and
generate the second determination region on the basis of a shape of the first determination region.

11. The storage medium according to claim 1, wherein the game program further causes the computer to:
control a position of the virtual camera in the virtual space; and
set the position of the virtual microphone to the position of the virtual camera in the virtual space.

12. The storage medium according to claim 1, wherein the game program further causes the computer to:
set a strength at which a first filter is applied to the first sound, on the basis of the distance between the first determination region and the virtual microphone;
when the first sound source is hidden on the basis of the result of the hiding determination as to the first sound source based on the positional relationship between the second determination region and the virtual microphone, further set the strength such that the first filter is applied more strongly, or set a strength at which a second filter is applied; and
apply a filter to the first sound, and output the first sound on the basis of the volume.

13. The storage medium according to claim 1, wherein the game program further causes the computer to:
calculate a localization of the first sound on the basis of a positional relationship between the first determination region and the virtual microphone; and
output the first sound on the basis of the set localization.

14. A game system comprising a processor configured to:
control a position of a virtual microphone in a virtual space;
for a virtual first sound source placed in the virtual space and associated with a first sound,
set a volume of the first sound such that the volume of the first sound is attenuated in accordance with a distance between a first determination region having a predetermined shape and the virtual microphone,
perform a hiding determination as to the first sound source on the basis of a positional relationship between the virtual microphone and a second determination region having a shape different from that of the first determination region, the shape of the second determination region satisfying at least that a part thereof is outside the first determination region or that a width thereof is smaller than that of the first determination region, and
set the volume of the first sound such that the volume of the first sound is further attenuated when the first sound source is hidden, on the basis of a result of the hiding determination; and
output the first sound on the basis of the set volume.

15. The game system according to claim 14, wherein the distance between the first determination region and the virtual microphone is a distance between a point, closest to the virtual microphone, on the first determination region and the position of the virtual microphone.

16. The game system according to claim 15, wherein the processor is configured to:
determine whether or not an obstacle object exists between a reference point based on the position of the virtual microphone and a point, closest to the reference point, on the second determination region in the virtual space; and
when it is determined that the obstacle object exists, determine that the first sound source is hidden.

17. The game system according to claim 15, wherein the processor is configured to:
determine whether or not an obstacle object exists between a reference point based on the position of the virtual microphone and a point, closest to the reference point, on the second determination region in the virtual space;
when it is determined that the obstacle object exists, further determine whether or not a path bypassing the obstacle object within a predetermined range exists between the virtual microphone and a point, closest to the virtual microphone, on the second determination region;
when it is determined that the path exists, determine that the first sound source is hidden to a first degree;
when it is determined that the path does not exist, determine that the first sound source is hidden to a second degree higher than the first degree; and
set the volume such that the volume is attenuated on the basis of the determined hiding degree.

18. The game system according to claim 17, wherein the processor is configured to:
when it is determined that the bypassing path does not exist, further determine whether or not a position of the reference point and the point closest to the reference point are positions indicating indoor spaces preset in the virtual space; and
when either one of the position of the reference point and the point closest to the reference point is the position indicating the indoor space, determine that the first sound source is hidden to a third degree higher than the second degree.

19. The game system according to claim 16, wherein
the first determination region has a three-dimensional shape having a plurality of surfaces, and
the second determination region has a planar shape along one of the surfaces of the first determination region.

20. The game system according to claim 16, wherein
an object corresponding to the first sound source is placed in the virtual space,
the first determination region is placed along the object corresponding to the first sound source, and
the second determination region has a shape in which the second determination region has a smaller width than the first determination region and protrudes toward a position where the object is not placed in the virtual space.

21. The game system according to claim 16, wherein
a waterfall object corresponding to the first sound source is placed in the virtual space,
the first determination region is placed along the waterfall object, and
the second determination region is placed along a surface, on a water surface side of the waterfall object, of the first determination region and has a planar shape in which the second determination region has a smaller width in a width direction of the waterfall object than the first determination region and protrudes toward an upper side of the waterfall object.

22. The game system according to claim 19, wherein the processor is configured to generate the second determination region on the basis of a shape of the first determination region.

23. The game system according to claim 21, wherein the processor is further configured to:
generate the first determination region on the basis of a shape of the waterfall object; and
generate the second determination region on the basis of a shape of the first determination region.

24. The game system according to claim 14, wherein the processor is further configured to:
control a position of the virtual camera in the virtual space; and
set the position of the virtual microphone to the position of the virtual camera in the virtual space.

25. The game system according to claim 14, wherein the processor is further configured to:
set a strength at which a first filter is applied to the first sound, on the basis of the distance between the first determination region and the virtual microphone;
when the first sound source is hidden on the basis of the result of the hiding determination as to the first sound source based on the positional relationship between the second determination region and the virtual microphone, further set the strength such that the first filter is applied more strongly, or set a strength at which a second filter is applied; and
apply a filter to the first sound, and output the first sound on the basis of the volume.

26. The game system according to claim 14, wherein the processor is further configured to:
calculate a localization of the first sound on the basis of a positional relationship between the first determination region and the virtual microphone; and
output the first sound on the basis of the set localization.

27. A game apparatus comprising a processor configured to:
control a position of a virtual microphone in a virtual space;
for a virtual first sound source placed in the virtual space and associated with a first sound,
set a volume of the first sound such that the volume of the first sound is attenuated in accordance with a distance between a first determination region having a predetermined shape and the virtual microphone,
perform a hiding determination as to the first sound source on the basis of a positional relationship between the virtual microphone and a second determination region having a shape different from that of the first determination region, the shape of the second determination region satisfying at least that a part thereof is outside the first determination region or that a width thereof is smaller than that of the first determination region, and
set the volume of the first sound such that the volume of the first sound is further attenuated when the first sound source is hidden, on the basis of a result of the hiding determination; and
output the first sound on the basis of the set volume.

28. The game apparatus according to claim 27, wherein the distance between the first determination region and the virtual microphone is a distance between a point, closest to the virtual microphone, on the first determination region and the position of the virtual microphone.

29. The game apparatus according to claim 28, wherein the processor is configured to:
determine whether or not an obstacle object exists between a reference point based on the position of the virtual microphone and a point, closest to the reference point, on the second determination region in the virtual space; and
when it is determined that the obstacle object exists, determine that the first sound source is hidden.

30. The game apparatus according to claim 28, wherein the processor is configured to:
determine whether or not an obstacle object exists between a reference point based on the position of the virtual microphone and a point, closest to the reference point, on the second determination region in the virtual space;
when it is determined that the obstacle object exists, further determine whether or not a path bypassing the obstacle object within a predetermined range exists between the virtual microphone and a point, closest to the virtual microphone, on the second determination region;
when it is determined that the path exists, determine that the first sound source is hidden to a first degree;
when it is determined that the path does not exist, determine that the first sound source is hidden to a second degree higher than the first degree; and
set the volume such that the volume is attenuated on the basis of the determined hiding degree.

31. The game apparatus according to claim 30, wherein the processor is configured to:
when it is determined that the bypassing path does not exist, further determine whether or not a position of the reference point and the point closest to the reference point are positions indicating indoor spaces preset in the virtual space; and
when either one of the position of the reference point and the point closest to the reference point is the position indicating the indoor space, determine that the first sound source is hidden to a third degree higher than the second degree.

32. A game processing method executed by a computer configured to control an information processing apparatus, the game processing method causing the computer to:
control a position of a virtual microphone in a virtual space;
for a virtual first sound source placed in the virtual space and associated with a first sound,
set a volume of the first sound such that the volume of the first sound is attenuated in accordance with a distance between a first determination region having a predetermined shape and the virtual microphone,
perform a hiding determination as to the first sound source on the basis of a positional relationship between the virtual microphone and a second determination region having a shape different from that of the first determination region, the shape of the second determination region satisfying at least that a part thereof is outside the first determination region or that a width thereof is smaller than that of the first determination region, and
set the volume of the first sound such that the volume of the first sound is further attenuated when the first sound source is hidden, on the basis of a result of the hiding determination; and
output the first sound on the basis of the set volume.

33. The game processing method according to claim 32, wherein the distance between the first determination region and the virtual microphone is a distance between a point, closest to the virtual microphone, on the first determination region and the position of the virtual microphone.

34. The game processing method according to claim 33, further causing the computer to:
determine whether or not an obstacle object exists between a reference point based on the position of the virtual microphone and a point, closest to the reference point, on the second determination region in the virtual space; and
when it is determined that the obstacle object exists, determine that the first sound source is hidden.

35. The game processing method according to claim 33, further causing the computer to:
determine whether or not an obstacle object exists between a reference point based on the position of the virtual microphone and a point, closest to the reference point, on the second determination region in the virtual space;
when it is determined that the obstacle object exists, further determine whether or not a path bypassing the obstacle object within a predetermined range exists between the virtual microphone and a point, closest to the virtual microphone, on the second determination region;
when it is determined that the path exists, determine that the first sound source is hidden to a first degree;
when it is determined that the path does not exist, determine that the first sound source is hidden to a second degree higher than the first degree; and
set the volume such that the volume is attenuated on the basis of the determined hiding degree.

36. The game processing method according to claim 35, further causing the computer to:
when it is determined that the bypassing path does not exist, further determine whether or not a position of the reference point and the point closest to the reference point are positions indicating indoor spaces preset in the virtual space; and
when either one of the position of the reference point and the point closest to the reference point is the position indicating the indoor space, determine that the first sound source is hidden to a third degree higher than the second degree.
